(19) United States
(12) Patent Application Publication
(10) Pub. No.: US 2015/0239079 A1
(43) Pub. Date: Aug. 27, 2015

(54) SCREW MOUNTING DEVICE

(71) Applicants: BOE TECHNOLOGY GROUP CO., LTD., Beijing (CN); HEFEI BOE DISPLAY LIGHT CO., LTD., Hefei, Anhui (CN)

(72) Inventor: Yi Wang, Beijing (CN)

(21) Appl. No.: 14/360,358

(22) PCT Filed: Jun. 18, 2013
(86) PCT No.: PCT/CN2013/077420

§ 371 Date: May 23, 2014

(30) Foreign Application Priority Data
Mar. 21, 2013 (CN) 201310091437.6

(51) Int. Cl. B23P 19/06

(52) U.S. Cl. CPC B23P 19/069

(57) ABSTRACT

A screw mounting device, including a rack; a guide rod, fixed vertically with respect to the rack; and a screw gun, provided with a guide way on one side thereof, the guide way in clamping connection with the guide rod so that a muzzle of the screw gun faces downward vertically, and the screw gun configured to be movable up and down along the guide rod, be movable downwards to the first and second pieces to be fixed that are provided below the screw gun and be capable of fixing them with screws.

### TECHNICAL FIELD

Embodiments of the present invention relate to a screw mounting device.

### BACKGROUND

For the present, the assembly manner in which screws are used for locking plays a primary role in the electronics, mechanics hardware and similar manufacture industries. But, the current screw locking manner mainly performs locking manually, such a manner is disadvantageous in that the man-hour for operation is long, the efficiency is low, and the work intensity is great; and further, it's easy to cause a locking deflection for the screws and cause that the screws can not be locked in position, and the like.

For example, during the process for making a backlight source of a liquid crystal display device, the frame of the backlight source and a lamp cover are required to be assembled and locked together with screws. The current method for assembling the lamp cover and the frame with screws is conducted as follows: firstly, an operator places the frame and the lamp cover onto an assembling jig, and then takes a screw gun and moves it to the screw stock, and the screw gun gets screws; then, the screw gun is moved to be above the frame and the lamp cover to lock the screws; and afterwards, the screw gun is laid aside and the locking of the screws is finished; finally, the screw gun is taken away.

### SUMMARY

Embodiments of present invention provide a screw mounting device, which ensures no locking deflection occurs for screws when the screws are fixed; and in the meantime, the work intensity of operators is reduced.

To achieve what is described above, the disclosure provides the following technical solutions.

A screw mounting device, comprises: a rack; a guide rod, fixed with respect to the rack in the vertical direction; and a screw gun, provided with a guide way on one side thereof; the guide way of the screw gun is in clamping connection with the guide rod so that the muzzle of the screw gun faces downward vertically, and the screw gun is configured to be movable up and down along the guide rod and be movable downwards to the first and second pieces to be fixed that are provided below the screw gun, and be capable of fixing the two pieces with screws.

In one embodiment, the screw mounting device further comprises: an elastic unit, the upper end thereof is fixed to the upper part of the rack, and the lower end thereof is fixed to the tail end of the screw gun.

In one embodiment, the guide rod is provided with a plurality of first stopper protrusions equally spaced along its length direction, the wall of the guide way of the screw gun is provided with second stopper protrusions corresponding to the first stopper protrusions along the length direction of the guide way; and the second stopper protrusions of the guide way of the screw gun are in contact with the first stopper protrusions of the guide rod so as to keep the screw gun and the guide rod in a standstill state with respect to each other.

In one embodiment, the screw mounting device further comprises: a screw gun retainer, the upper end face thereof being retained with the lower end of the elastic unit, the lower end face thereof being provided with a clamping slot, and the clamping slot is in clamping connection with the tail end of the screw gun; a regulation rail, fixed with the rack; and a connection member, in clamping connection with the regulation rail and fixed with the guide rod, so as to allow the connection member to move horizontally along the regulation rail and thus to bring the screw gun to move horizontally along the clamping slot of the screw gun retainer.

In one embodiment, the regulation rail is provided with a plurality of third stopper protrusions equally spaced along its length direction and the third stopper protrusions is in contact with the connection member.

In one embodiment, a plurality of screw guns is clamped into the clamping slot of the screw gun retainer, and each of the screw guns corresponds to one guide rod with its guide way in clamping connection with the guide rod corresponding therewith.

In one embodiment, the screw mounting device further comprises: storage units for storing screws, and corresponding to the screw guns in a one-to-one manner; movable stands, configured to be movable with respect to the rack; the movable stands correspond to the storage units in a one-to-one manner and the storage unit is fixed to its corresponding movable stand; when the movable stand fixed with the storage unit is moved to be below its corresponding screw gun, the screw gun is just opposite to its corresponding storage unit and the screw gun can move downward along the guide rod to take a screw from the storage unit; and when the movable stand fixed with the storage unit is moved to be shifted from the underside of its corresponding screw gun, the screw gun moves downward along the guide rod to the first and second pieces to be fixed and can fix the first and second pieces with screws.

In one embodiment, the movable stand can move between a side of the rack connected with the guide rod and a side of the rack opposite to the side connected with the guide rod, so that the movable stand can move to be below its corresponding screw gun or the movable stand can move to be shifted from the underside of its corresponding screw gun.

In one embodiment, the screw mounting device further comprises: a sensor unit for sensing the state of the screw gun and a control unit for controlling the movable stand, the sensor unit is in communication with the control unit, and the control unit is in communication with the movable stand.

In one embodiment, the screw mounting device further comprises a working platform provided below the bracket and a rotation driving unit connected therewith; the working platform is used for the placement of the first and second pieces to be fixed, and the rotation driving unit can drive the working platform to rotate.

In the screw mounting device provided by the embodiments of present invention, the guide rod is fixed with respect to the rack in the vertical direction, and the screw gun can move vertically along the guide rod. In this way, when the first and second pieces to be fixed are fixed together with screws, firstly, the first and second pieces to be fixed are placed below the screw gun; then, a screw is supplied to the muzzle of the screw gun; then, the screw gun moves downwards along the guide rod to the first and second pieces to be fixed and fixes the first and second pieces with screws. The screw mounting device provided by the embodiments of present invention ensures no locking deflection occurs for the screws when the screws are fixed by the screw gun; and in the meantime, the work intensity of the operators is reduced.

### BRIEF DESCRIPTION OF THE DRAWINGS

FIG. 1 is a three-dimensional view of an embodiment of the screw mounting device of the disclosure;

FIG. 2 is a front view of the screw mounting device illustrated in FIG. 1;

FIG. 3 is a side view of the screw mounting device illustrated in FIG. 1; and

FIG. 4 is a three-dimensional view from another viewpoint of the screw mounting device illustrated in FIG. 1.

### Reference Numerals of the Main Components:

100: rack, 200: guide rod, 300: screw gun, 400: elastic unit, 500: screw gun retainer, 600: regulation rail, 700: connector, 810: storage unit, 820: movable stand, 900: working platform.

### DETAILED DESCRIPTION

The technical solutions of the embodiments will be described in a clearly and fully understandable way in connection with the drawings related to the embodiments of the invention. Apparently, the described embodiments are just a part but not all of the embodiments of the invention.

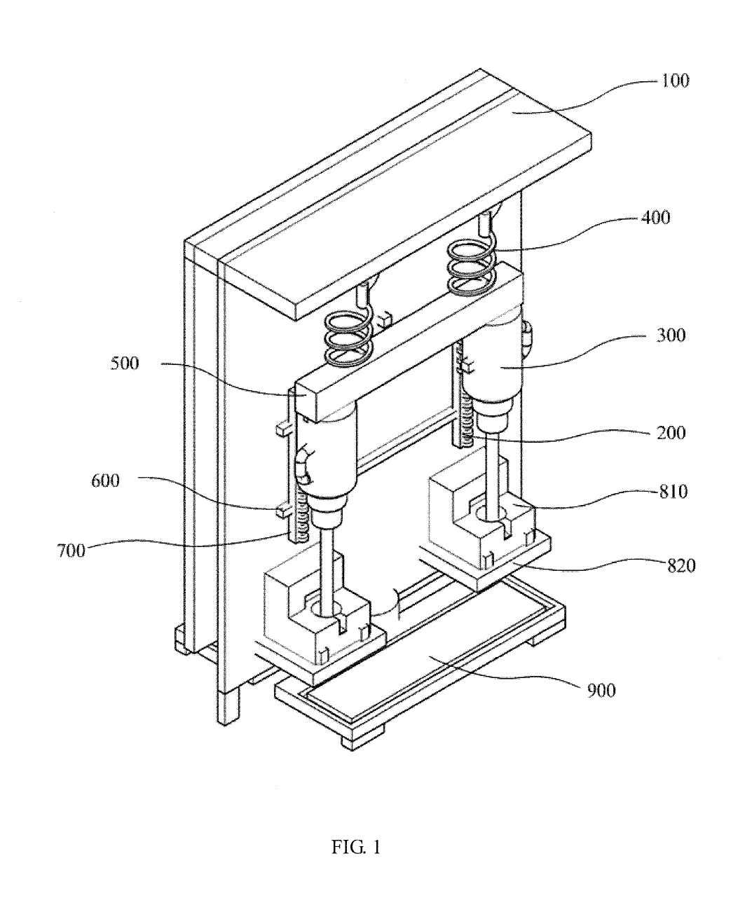

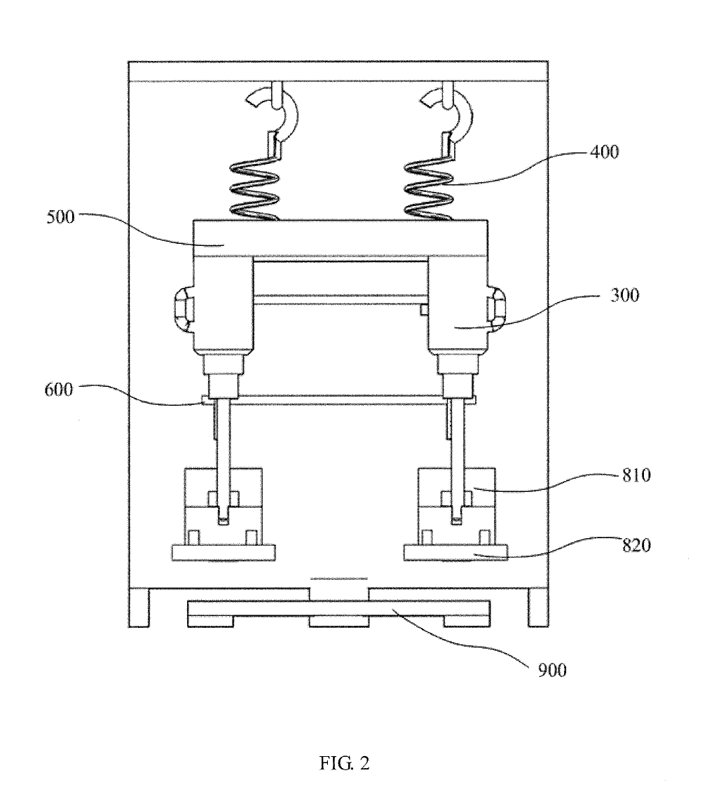

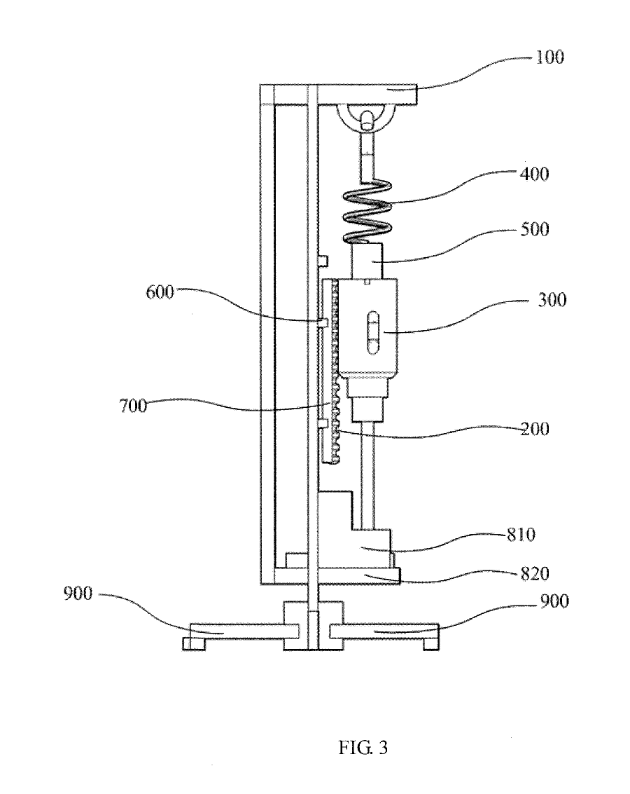

The screw mounting device according to the first embodiment of the present invention is illustrated in FIGS. 1, 2 and 3; FIG. 1 is a three-dimensional view of an embodiment of the screw mounting device of the disclosure; FIG. 2 is a front view of the screw mounting device illustrated in FIG. !; FIG. 3 is a side view of the screw mounting device illustrated in FIG. 1; and the screw mounting device comprises: a rack 100; a guide rod 200, fixed with respect to the rack in the vertical direction; and a screw gun 300, provided with a guide way on one side thereof The guide way of the screw gun 300 is in clamping connection with the guide rod 200 so that the muzzle of the screw gun 300 faces downward vertically, the screw gun 300 is configured to be moved up and down along the guide rod 200, and is movable downward up to the first and second pieces to be fixed that are provided below the screw gun and capable of fixing the pieces with screws.

In the screw mounting device provided by the present embodiment, the guide rod 200 is fixed with respect to the rack in the vertical direction, and the screw gun 300 can be movable up and down along the guide rod. Thus, when the first and second pieces to be fixed are fixed together with screws, firstly, the first and second pieces to be fixed are placed below the screw gun; then, the a screw is supplied to the muzzle of the screw gun; and afterwards, the screw gun moves downward along the guide rod to the first and second pieces to be fixed and fixes them with screws. The screw gun fixing screws is a currently well-established technology and is not the highlight of the present embodiment, so the detailed description thereof is omitted herein. In the screw mounting device provided by the present embodiment, the guide rod is fixed with respect to the rack in the vertical direction, and the screw gun is movable vertically along the guide rod, so that the muzzle of the screw gun is kept always downward vertically, thus it is ensured that no locking deflection occurs for the screws when the screws are fixed by the screw gun; and in the meantime, the work intensity of the operators is reduced.

An embodiment, as the second embodiment of the present invention, gives further illustration of the screw mounting device based on the first embodiment:

As illustrated in FIGS. 1, 2 and 3, the screw mounting device further comprises an elastic unit 400, and the upper end thereof is fixed with the rack 100; and the tail end of the screw gun 300 is held with respect to the lower end of the elastic unit 400.

When the screw gun 300 is not acted by an external forces, the screw gun 300 is kept at a certain initial position by virtue of the elastic force from the elastic unit 400; and when the screw gun 300 is acted by a downward external force, the elastic unit 400 is stretched, and the screw gun 300 moves downward along the guide rod to the first and second pieces to be fixed and fixes them with screws; afterwards, the external force is removed, and the screw gun 300 returns to its original initial position under the effect of the elastic force from the elastic unit 400. Thus, with the elastic force from the elastic unit, the screw gun is returned to its original initial position, which reduces the operation steps of the operators and eases the work intensity for the operators.

An embodiment, as the third embodiment of the present invention, gives further illustration of the screw mounting device based on the second embodiment:

As illustrated in FIGS. 1 and 3, the guide rod 200 is provided with a plurality of first stopper protrusions spaced along its length direction, the wall of the guide way of the screw gun is provided with second stopper protrusions corresponding to the first stopper protrusions along the length direction of the guide way. The second stopper protrusions of the guide way of the screw gun contact with the first stopper protrusions of the guide rod so as to keep the screw gun and the guide rod in a standstill state with respect to each other.

The second stopper protrusions of the guide way of the screw gun contact with the first stopper protrusions of the guide rod so as to keep the screw gun and the guide rod in a standstill state with respect to each other; in this way, when the screw gun is acted by a force, the force between the second stopper protrusions of the guide way and the first stopper protrusions of the guide rod is needed to be overcome, which avoids the phenomena that the movement of the screw gun along the guide rod upward or downward is too violent, and then affords a certain safeguard for the screw mounting device.

An embodiment, as the fourth embodiment of the present invention, gives further illustration of the screw mounting device based on the second and third embodiments.

As illustrated in FIGS. 1, 2 and 3, the screw mounting device further comprises: a screw gun retainer 500, with the upper end face thereof being retained with the lower end of the elastic unit 400, the lower end face thereof being provided with a clamping slot, and the clamping slot being in clamping connection with the tail end of the screw gun 300; a regulation rail 600, fixed with the rack 100; and a connection member 700, in clamping connection with the regulation rail 600 and fixed with the guide rod 200, so as to allow the connection member 700 to move horizontally along the regulation rail 600 and thus to bring the screw gun 300 to move horizontally along the clamping slot of the screw gun retainer 500.

The connection member can move horizontally along the regulation rail and thus bring the screw gun to move horizontally along the clamping slot of the screw gun retainer, and in this way, the screw gun can move in the horizontal direction so as to enable the flexible regulation of the position in the horizontal direction of the screw gun, and to facilitate the operator to regulate the screw gun according to the operation environment.

An embodiment, as the fifth embodiment of the present invention, gives further illustration of the regulation rail based on the fourth embodiment.

The regulation rail is provided with a plurality of third stopper protrusions equally spaced along its length direction, and the third stopper protrusions contact with the connection member.

In this way, when the screw gun is moved horizontally, the force between the third stopper protrusions of the regulation rail and the connection member is to be overcome, which avoids the phenomena that the horizontal movement of the screw gun is too violent and then affords a certain defense for the screw mounting device.

An embodiment, as the sixth embodiment of the present invention, gives further illustration of the screw mounting device based on the fourth and the fifth embodiments.

As illustrated in FIGS. 1 and 2, a plurality of the screw guns 300 is clamped into the clamping slot of the screw gun retainer 700, each of the screw guns 300 corresponds to one guide rod 200 with the guide way thereof being in clamping connection with the guide rod corresponding therewith.

A plurality of screw guns is clamped within the clamping slot of the screw gun retainer, and in this way, when the screw gun retainer is acted by a downward force or by an upward force from the elastic unit, the a plurality of the screw guns moves downward or upward simultaneously, which simplifies the operation by the operator, and improves the working efficiency; and the horizontal distance between the plurality of the screw guns can be regulated so as to be applicable to products with different screw pitch.

An embodiment, as the seventh embodiment of the present invention, gives further illustration of the screw mounting device based on any one of the first to the sixth embodiments.

As illustrated in FIGS. 1, 2 and 3, the screw mounting device further comprises: storage units 810 for storing the screws and corresponding to the screw guns 300 in a one-to-one manner; and movable stands 820, which are configured to be movable with respect to the rack 100. The movable stands 820 corresponds to the storage units 810 in a one-to-one manner and the storage unit 810 is fixed to its corresponding movable stand 820.

When the movable stand 820 fixed with the storage units is moved to be below its corresponding screw gun 300, the screw gun 300 is just opposite to its corresponding storage unit 810 and the screw gun 300 can move downward along the guide rod to take a screw from the storage unit 810.

When the movable stand 820 fixed with the storage unit is moved to be shifted from the underside of its corresponding screw gun 300, the screw gun 300 can move downward along the guide rod to the first and second pieces to be fixed and can fix the first and second pieces with screws.

In this way, the screw mounting device is allowed to take and fix the screws, which simplifies the operation by the operator and improves the working efficiency.

An embodiment, as the eighth embodiment of the present invention, gives an explanation of a preferred manner of the movable stand based on the seventh embodiment:

As illustrated in FIGS. 1 and 3, the movable stand 820 is movable between a side of the rack connected with the guide rod and a side of the rack opposite to the side connected with the guide rod, so that the movable stand 820 can move to be below its corresponding screw gun or the movable stand can be moved to be shifted from the underside of its corresponding screw gun.

It is to be noted that, the form of the movable stand is not limited to the present embodiment, as long as it can achieve that the movable stand can be to be below its corresponding screw gun or to be shifted from the underside of its corresponding screw gun, and it's only illustrated by way of example.

An embodiment, as the ninth embodiment of the present invention, gives further illustration of the screw mounting device based on the seventh and eighth embodiments respectively.

The screw mounting device further comprises: a sensor unit for sensing the state of the screw gun and a control unit for controlling the movable stand; the sensor unit is in communication with the control unit, and the control unit is in communication with the movable stand.

In this way, conditions are provided for the control unit to control the movable stand correspondingly according to the signals from the sensor unit.

An embodiment, as the tenth embodiment of the present invention, gives further illustration of the screw mounting device based on any one of the above embodiments, respectively:

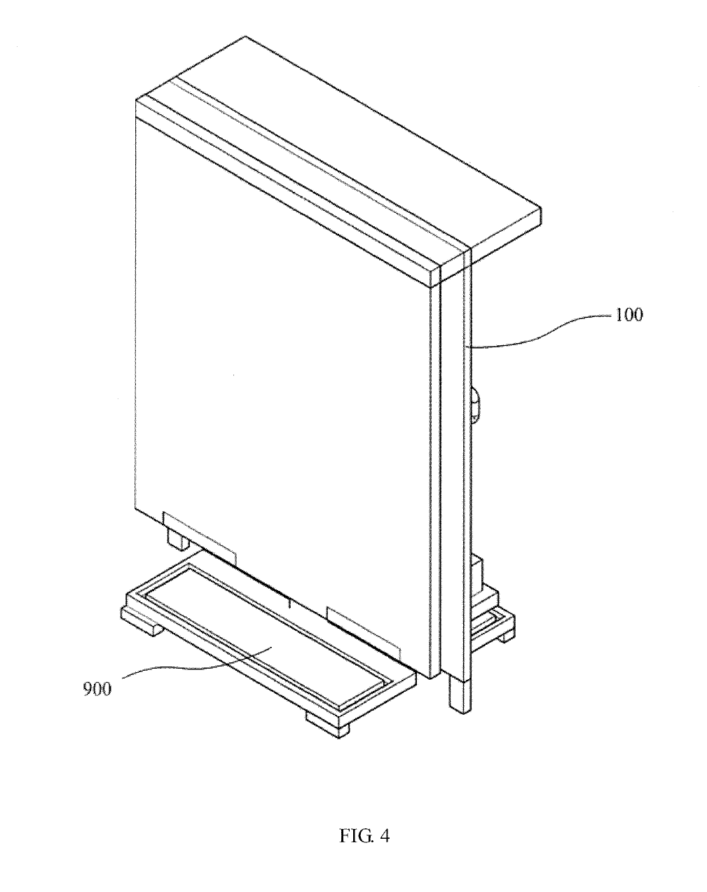

As illustrated in FIGS. 3 and 4, FIG. 4 is a three-dimensional view from another viewpoint of the screw mounting device illustrated in FIG. 1, and the screw mounting device comprises a working platform 900 provided below the rack and a rotation driving unit connected therewith.

The working platform 900 is used for the placement of the first and second pieces to be fixed, and the rotation driving unit can drive the working platform 900 to rotate.

In this way, a portion of the working platform can be used for the screw fixing operation performed by the screw gun; and at the same time, another portion of the working platform can be used for the placement of the first and second pieces to be fixed, for preparation for the subsequent screw fixing operation; and after the working platform is driven to rotate by the rotation driving unit, the two portions of the working platform are transformed in their functions.

Apparently, various modification and variations can be made to the embodiments of the present invention by the person skilled in the art without departing from the spirit and scope of the present invention. Thereby, the present invention intends to encompass all such modifications and variations, provided they are within the scope of the claims of the present invention and the equivalents.

1. A screw mounting device, comprising:
a rack;
a guide rod, fixed with respect to the rack in a vertical direction; and
a screw gun, provided with a guide way on one side thereof, the guide way being in clamping connection with the guide rod so that a muzzle of the screw gun faces downward vertically, and the screw gun being configured to be movable up and down along the guide rod and be movable downward to a first and a second pieces to be fixed that are below the screw gun and fix the first and second pieces with screws.

2. The screw mounting device as claimed in claim 1, further comprising:
an elastic unit, an upper end thereof being fixed to an upper part of the rack, and a lower end thereof being fixed to a tail end of the screw gun.

3. The screw mounting device as claimed in claim 2, wherein the guide rod is provided with a plurality of first stopper protrusions equally spaced along its length direction, a wall of the guide way of the screw gun is provided with second stopper protrusions corresponding to the first stopper protrusions along a length direction of the guide way; and the second stopper protrusions of the guide way of the screw gun are capable of contacting with the first stopper protrusions of the guide rod to keep the screw gun and the guide rod in a standstill state with respect to each other.

4. The screw mounting device as claimed in claim 2, further comprising:
a screw gun retainer, an upper end face thereof being retained with a lower end of the elastic unit, a lower end face thereof being provided with a clamping slot, and the clamping slot being in clamping connection with a tail end of the screw gun;
a regulation rail, fixed with the rack; and
a connection member, in clamping connection with the regulation rail and fixed with the guide rod so as to allow the connection member to move horizontally along the regulation rail and thus to drive the screw gun to move horizontally along the clamping slot of the screw gun retainer.

5. The screw mounting device as claimed in claim 4, wherein the regulation rail is provided with a plurality of third stopper protrusions equally spaced along its length direction, and the third stopper protrusions are in contact with the connection member.

6. The screw mounting device as claimed in claim 4, wherein a plurality of screw guns is clamped into the clamping slot of the screw gun retainer, and each of the screw guns corresponds to one guide rod with the guide way thereof in clamping connection with the guide rod corresponding therewith.

7. The screw mounting device as claimed in claim 4, further comprising:
storage units for storing screws and corresponding to the screw guns in a one-to-one manner; and
movable stands, configured to be movable with respect to the rack; the movable stands corresponding to the storage units in a one-to-one manner and the storage unit being fixed to its corresponding movable stand;
when a movable stand fixed with a storage unit is moved to be below its corresponding screw gun, the screw gun is just opposite to its corresponding storage unit and the screw gun moves downward along the guide rod to take a screw from the storage unit; and
when the movable stand fixed with a storage unit is moved to be shifted from the underside of its corresponding screw gun, the screw gun moves downward along the guide rod to the first and second pieces to be fixed and fixes the first and second pieces with screws.

8. The screw mounting device as claimed in claim 7, wherein the movable stand moves between a side of the rack connected with the guide rod and a side of the rack opposite to the side connected with the guide rod, so that the movable stand moves to be below its corresponding screw gun or the movable stand moves to be shifted from the underside of its corresponding screw gun.

9. The screw mounting device as claimed in claim 8, further comprising:
a sensor unit for sensing a state of the screw gun and a control unit for controlling the movable stand, the sensor unit being in communication with the control unit, and the control unit being in communication with the movable stand.

10. The screw mounting device as claimed in claim 9, further comprising a working platform provided below the rack and a rotation driving unit connected therewith;
wherein the working platform is used for placement of the first and second pieces to be fixed, and the rotation driving unit drives the working platform to rotate.

11. The screw mounting device as claimed in claim 3, further comprising:
a screw gun retainer, an upper end face thereof being retained with a lower end of the elastic unit, a lower end face thereof being provided with a clamping slot, and the clamping slot being in clamping connection with a tail end of the screw gun;
a regulation rail, fixed with the rack; and
a connection member, in clamping connection with the regulation rail and fixed with the guide rod so as to allow the connection member to move horizontally along the regulation rail and thus to drive the screw gun to move horizontally along the clamping slot of the screw gun retainer.

12. The screw mounting device as claimed in claim 11, wherein the regulation rail is provided with a plurality of third stopper protrusions equally spaced along its length direction, and the third stopper protrusions are in contact with the connection member.

13. The screw mounting device as claimed in claim 11, wherein a plurality of screw guns is clamped into the clamping slot of the screw gun retainer, and each of the screw guns corresponds to one guide rod with the guide way thereof in clamping connection with the guide rod corresponding therewith.

14. The screw mounting device as claimed in claim 11, further comprising:
storage units for storing screws and corresponding to the screw guns in a one-to-one manner; and
movable stands, configured to be movable with respect to the rack; the movable stands corresponding to the storage units in a one-to-one manner and the storage unit being fixed to its corresponding movable stand;
when a movable stand fixed with a storage unit is moved to be below its corresponding screw gun, the screw gun is just opposite to its corresponding storage unit and the screw gun moves downward along the guide rod to take a screw from the storage unit; and
when the movable stand fixed with a storage unit is moved to be shifted from the underside of its corresponding screw gun, the screw gun moves downward along the guide rod to the first and second pieces to be fixed and fixes the first and second pieces with screws.

15. The screw mounting device as claimed in claim 14, wherein the movable stand moves between a side of the rack connected with the guide rod and a side of the rack opposite to the side connected with the guide rod, so that the movable stand moves to be below its corresponding screw gun or the movable stand moves to be shifted from the underside of its corresponding screw gun.

16. The screw mounting device as claimed in claim 15, further comprising:
a sensor unit for sensing a state of the screw gun and a control unit for controlling the movable stand, the sensor unit being in communication with the control unit, and the control unit being in communication with the movable stand.

17. The screw mounting device as claimed in claim 16, further comprising a working platform provided below the rack and a rotation driving unit connected therewith;
wherein the working platform is used for placement of the first and second pieces to be fixed, and the rotation driving unit drives the working platform to rotate.
